(19) United States
(12) Patent Application Publication
(10) Pub. No.: US 2026/0239146 A1
(43) Pub. Date: Aug. 13, 2026

(54) SYSTEMS AND METHODS FOR MITIGATING SERVICE INTERRUPTIONS WHEN APPLYING NETWORK FUNCTION UPDATES

(71) Applicant: T-MOBILE INNOVATIONS LLC, Overland Park, KS (US)

(72) Inventors: Rahul Rashmikant AMIN, Issaquah, WA (US); Kumar VELUSAMY, Overland Park, KS (US)

(21) Appl. No.: 19/050,982

(22) Filed: Feb. 11, 2025

(51) Int. Cl. H04W 36/30; H04W 24/04; H04W 36/00

(52) U.S. Cl. CPC H04W 36/305; H04W 24/04; H04W 36/0016

(57) ABSTRACT

Embodiments of the present disclosure are directed to systems and methods for managing network accessibility of a user equipment (UE) in a communications network. For example, a user equipment's (UE) compatibility for accessing a roaming network may be determined by analyzing device information of the UE and one or more features of the roaming network. A roaming subscription information (RSI) list associated with the UE may be modified based on the analysis in order to appropriately manage the accessibility of the UE to the roaming network.

### SUMMARY

The present disclosure is directed, in part, to managing Network Function (NF) updates of a NF within an NF-Set in a communications network, substantially as shown and/or described in connection with at least one of the figures, and as set forth more completely in the claims.

According to various aspects of the technology, a communications network, updating a NF involves a carefully managed process to ensure service continuity and minimize disruptions. NFs, such as the Access and Mobility Function (AMF) or Session Management Function (SMF), are responsible for critical operations, including managing mobility, session setup, and resource allocation. During an update, the NF being upgraded or replaced transfers its active responsibilities to other instances within the same NF-Set. For example, when an AMF undergoes an update, subscriber sessions must migrate to other AMFs within the set. This migration typically occurs through state synchronization, where the session data of connected devices (User Equipment, or UEs) is shared among the NFs to maintain consistency. For UEs in IDLE MODE, state changes required for migration often happen during a transition initiated either by the UE or the network. The update process also relies on established signaling protocols, such as N1 for direct communication with the UE and N2 for interactions with the radio network, to manage these transitions. Despite the efforts to ensure a smooth handover, simultaneous network and user-initiated procedures can occasionally lead to session mismatches or service interruptions during the update process.

To address the challenges associated with updating a NF in a communications network, service interruptions and session mismatches may be mitigated through improved coordination and proactive measures. One approach involves preemptively synchronizing session state information across the network. Another approach involves actively managing UE state transitions by triggering network-initiated procedures to bring all affected UEs into a known and stable state, such as ACTIVE mode, before proceeding with the update. This method helps reduce the risk of collisions between concurrent procedures initiated by the UE and the network. Together or alone, these strategies enhance the network's resilience and ensure a more reliable user experience during NF updates.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed;

FIG. 4 illustrates another example flow diagram in which implementations of the present disclosure may be employed;

FIG. 5 illustrates another example flow diagram in which implementations of the present disclosure may be employed;

FIG. 6 illustrates a flow chart of an exemplary method for mitigating service interruptions for a user equipment (UE) in a communications network in which implementations of the present disclosure may be employed;

FIG. 7 illustrates another flow chart of an exemplary method for mitigating service interruptions for a user equipment (UE) in a communications network in which implementations of the present disclosure may be employed; and

FIG. 8 illustrates a flow chart of another exemplary method for mitigating service interruptions for a plurality of user equipment (UE) in a communications network in which implementations of the present disclosure may be employed.

### DETAILED DESCRIPTION

By way of background, updating a NF that is part of an NF-Set in a communications network is a complex process that requires careful coordination to maintain service continuity. An NF-Set is a collection of functionally equivalent NFs, such as AMFs or SMFs, that collectively handle a group of UE sessions. During the update of one NF in the NF-Set, its responsibilities for managing active and idle UEs are temporarily shifted to other NFs within the set. This may involve transferring subscriber contexts, which include mobility state, session information, and other operational parameters, to help ensure uninterrupted network functionality. The process may begin with the identification of the NF to be updated and a notification to the network that the NF will temporarily cease operations. This status change is typically communicated to other NFs and network components via the Network Repository Function (NRF). Following the notification, the impacted NF prepares for the update by checking that all active UE sessions are either completed or handed over to other NFs in the set. For UEs in IDLE MODE, which may not actively communicate with the network, the migration may only occur when the UE initiates a state change (e.g., transitioning to ACTIVE mode for data or voice services) or the network sends a page to the UE. This migration process introduces several challenges. First, timing conflicts can arise when both the network and the UE independently initiate procedures. For instance, a UE in IDLE MODE may initiate a state transition at the same time that the Policy Control Function (PCF) or SMF triggers a dedicated bearer setup. Such simultaneous triggers can lead to collisions in the SMF, causing failures in session establishment or mismatches in resource allocation. Second, inconsistencies can occur between the SMF and the Radio Access Network (RAN). For example, while the SMF assigns a new AMF from the set to handle a migrating UE, the gNodeB (gNB) in the RAN may retain references to the old, now unavailable AMF. This mismatch can result in dropped sessions or disrupted services, particularly for latency-sensitive applications like voice and video calls. Third, the sheer volume of UEs in a large-scale network adds complexity to the migration process. During an update, the NF being upgraded may manage thousands or even millions of UEs, all of which need to be smoothly transitioned to other NFs in the set. The simultaneous migration of multiple UEs can place a significant load on the remaining NFs in the set, increasing the risk of resource contention and degraded network performance. Lastly, the coordination of signaling between different network entities is challenging-the SMF, AMFs, NRF, and RAN must operate in harmony to ensure that subscriber contexts are updated and that all affected network elements are aware of the new operational state. Any delay or miscommunication in this signaling process can result in session failures or inconsistencies in how the UE is managed.

To address the challenges of updating a NF within an NF-Set, the communications network may implement systems and methods focused on proactive coordination, intelligent timing, and/or enhanced signaling mechanisms that aim to mitigate session mismatches, collisions, and service interruptions while ensuring seamless migration of UE to other NFs during the update process. These methods may leverage dynamic state management, configurable timers, and/or proactive signaling to help ensure seamless NF updates.

For example, an approach focusing on minimizing signaling overhead while addressing potential collision scenarios may be utilized. In such a scenario, when the SMF receives an AMF failure notification from the NRF, it may update the subscriber session database with the new AMF IPs based on a load-balanced response from the AMF-Set. If the SMF subsequently receives a dedicated bearer setup notification (e.g., N7UN) from the PCF, it may wait for an indication from a configurable timer before initiating N1N2 messages to the UE. If a UE-initiated IDLE MODE exit occurs before the timer expires, the SMF may prioritize the UE's request, process the N11 update, and complete the session migration to the new AMF without conflict. In cases where no UE-initiated update is received, the SMF may proceed with the N1N2 messaging after the timer expires, helping ensure session continuity through orderly network-initiated procedures. Any configurable timers may also be dynamically adjusted based on network conditions, such as signaling load or the number of UEs in the NF-Set, helping to optimize the duration to prevent collisions without introducing delays.

In another example, a proactive strategy to manage the UE state transitions may be utilized. After receiving an AMF failure notification, the SMF may select new AMF IPs from the AMF-Set and initiate IDLE MODE exit procedures for all UEs managed by the failed AMF by sending N1N2 messages through the newly assigned AMF. This may force all affected UEs into ACTIVE MODE, helping ensure that session contexts are re-established with the new AMF before any collisions can occur. By proactively managing these state transitions, the risk of simultaneous procedures from the UE and the network may be mitigated, ensuring smooth migrations and minimizing disruptions.

To further enhance reliability, additional strategies may be implemented alone or along side the previously discussed strategies may be utilized. During high-load scenarios, batch processing may prioritize UEs based on criteria such as session type, location, and/or priority, helping ensure real-time services like voice or video are not affected. Enhanced signaling coordination within the SMF

Accordingly, a first aspect of the present disclosure is directed to a system for mitigating service interruptions for a user equipment (UE) in a communications network. The system includes a network device (e.g., a SMF) comprising one or more processors. The system further includes a non-transitory computer-readable media configured to receive, at the SMF, a failure notification for a Network Function (NF) within an NF-Set from a Network Repository Function (NRF). The computer-readable media is further configured to migrate subscriber session data of the UE associated with the failed NF to a new NF within the NF-Set. The computer-readable media is further configured to initiate a configurable timer. The computer-readable media is further configured to receive a request for an IDLE MODE exit procedure from the UE. The computer-readable media is further configured to process the IDLE MODE exit procedure to complete migration of subscriber session data of the UE to the new NF based on a determination that the timer has not expired.

A second aspect of the present disclosure is directed to a system for mitigating service interruptions for a user equipment (UE) in a communications network. The system includes a network device (e.g., a SMF) comprising one or more processors. The system further includes a non-transitory computer-readable media configured to receive, at the SMF, a failure notification for a Network Function (NF) within an NF-Set from a Network Repository Function (NRF). The computer-readable media is further configured to migrate subscriber session data of the UE associated with the failed NF to a new NF within the NF-Set. The computer-readable media is further configured to initiate a configurable timer. The computer-readable media is further configured to receive a dedicated bearer setup notification associated with the UE. The computer-readable media is further configured to initiate state transition signaling to the UE based on a determination that the timer has expired.

A third aspect of the present disclosure is directed to a system for mitigating service interruptions for a plurality of user equipment (UE) in a communications network. The system includes a network device (e.g., a SMF) comprising one or more processors. The system further includes a non-transitory computer-readable media configured to receive, at the SMF, a failure notification for a Network Function (NF) within an NF-Set from a Network Repository Function (NRF). The computer-readable media is further configured to migrate subscriber session data of the plurality UEs associated with the failed NF to one or more different NFs within the NF-Set. The computer-readable media is further configured to initiate state transition signaling to the plurality of UEs.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, a “Network Function (NF)” may refer to a modular and/or software-based component of a communications network the may perform specific roles in managing and delivering services. Examples of NFs include the SMF, responsible for session control and resource allocation, the AMF, which handles user registration and mobility, and the Policy Control Function (PCF), which enforces policies and Quality of Service (QoS) rules. Each NF may interact with other NFs to help enable dynamic, scalable, and efficient network options.

As used herein, a “NF-Set” may refer to a group of functionally equivalent NFs that work together to distribute the workload and ensure redundancy and reliability. For example, an AMF-Set may consist of multiples AMFs, each capable of managing UE sessions and mobility tasks. NFs within an NF-Set may share responsibilities and synchronize state information.

As used herein, “IDLE MODE” and “ACTIVE MODE” may represent the two primary operational states of a UE that determine its level of interaction with the network. These states are part of the mobility management framework that helps with efficient resource utilization and connectivity for UEs. For example, IDLE MODE may represent a low-power state in which the UE is not actively engages in data transmission or reception but remains registered with the network. In IDLE MODE, the UE may periodically listen for paging messages from the network to maintain connectivity and can quickly transition to ACTIVE MODE when needed. IDLE MODE may reduce power consumption for the UE and minimize signaling overhead in the network, as no active data sessions may be maintained. ACTIVE MODE, on the other hand, is a high-power state in which the UE actively exchanges data with the network. ACTIVE MODE may be used during voice calls, video streaming, file downloads, or applications requiring continuous connectivity. The transition between IDLE MODE and ACTIVE MODE is useful for maintaining efficient network operation and service continuity. For example, when a UE in IDLE MODE receives an incoming call or initiates data usage, it transitions to ACIVE MODE through signaling processes like the “IDLE MODE exit procedure.” Conversely, when the UE becomes inactive for a period of time, it may return to IDLE MODE to conserve resources. These transitions may be managed by NFs like the AMF and the SMF.

As used herein, “N1N2 messages” may refer to a combined signaling mechanism used to coordinate state transitions and session management between the network and a UE. The N1 component may represent the direct signaling interface between the UE and the AMF. The N2 component may pertain to the interface between the AMF and the Radio Access Network (RAN), such as a gNodeB (gNB). Together, the N1N2 messages may help enable the transfer of information for session establishment, modification, and/or termination.

As used herein, a “dedicated bearer setup (N7UN)” may refer to a signaling procedure initiated to establish a dedicated bearer for a QoS flow between a UE and the network. In the dedicated bearer setup process, the PCF may send an N7UN message to the SMF, providing instructions for creating the bearer. The SMF may process the request and communicate with the AMF and the RAN to allocate resources. It may also inform the UE of the bearer setup through N1 signaling.

As used herein, a “configurable timer” may refer to a parameter used by the SMF to control the timing of specific operations, helping to ensure orderly execution of signaling procedures and mitigating potential conflicts. The timer may be dynamically set based on network policies, operational requirements, and the current state of the network. For example, during events like NF updates or failures, the SMF may receive a notification from the NRF about an AMF status change and initiate the configurable timer to delay initiating certain signaling processes, such as N1N2 messages, to allow time for other procedures, such as database updates or UE-initiated requests, to complete. By introducing this delay, the SMF may be able to prioritize higher-priority operations and prevent collisions between network-initiated and UE-initiated procedures, which could otherwise result in session termination or resource allocation mismatches.

As used herein, “subscriber session data” may refer to the collection of information maintained by the network to manage and support a UE's connectivity, mobility, and/or service delivery. Subscriber session data may include various components, such as NF-Set assignments, mobility state, and/or bearer information. This data may be dynamically updated as the UE moves through the network or as its service needs change. For example, during an AMF upgrade, subscriber session data may be updated to point to a new AMF within the same AMF-Set, helping ensure continuity of service. Similarly, during a state transition from IDLE MODE to ACTIVE MODE, the subscriber session data may be used to establish the appropriate context for resource allocation and QoS enforcement.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

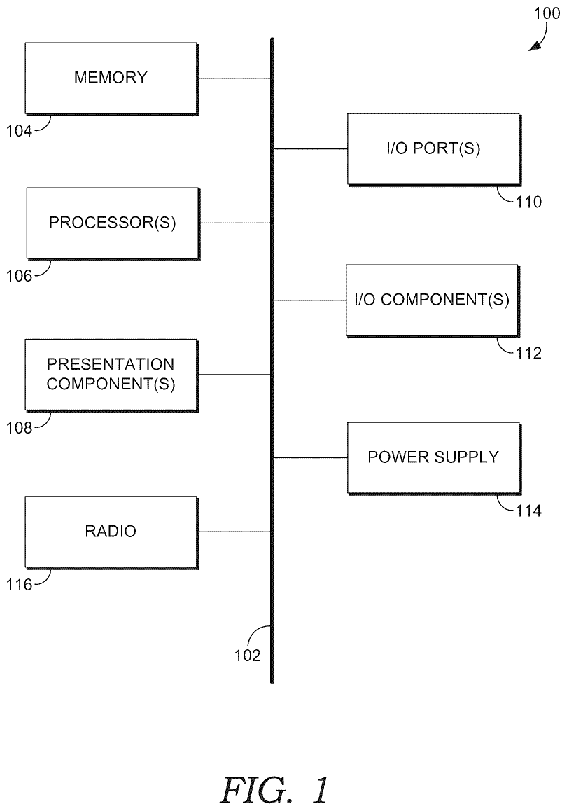

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

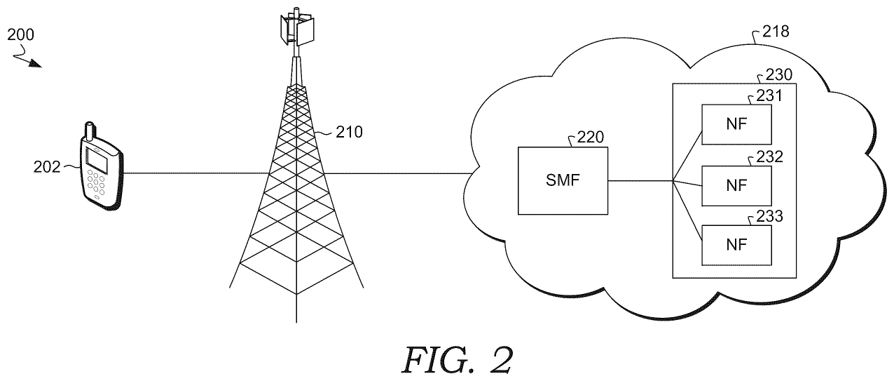

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a core network 218, an SMF 220, an NF-Set 230, and NFs 231-233, though in some implementations, it may not be necessary for certain features to be present. The network environment may include a number of routers, switches, and the like. The network environment 200 is generally configured for wirelessly connecting the UE 202 to data or services that may be accessible through the core network 218, or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The core network 218 may provide services and connectivity to the UE 202. For example, the core network 218 may manage the routing, authentication, and delivery of voice, data, and messaging services to the UE 202, regardless of whether the UE is operating within its home network. In some aspects, the core network 218 may include packet gateways and session management functions that help control the UE's 202 access to external data networks and multimedia services. For example, the core network 218 may communicate with the base station 210 to provide services to the UE 202.

When the UE 202 is in IDLE MODE and seeks to reconnect to the core network 218 through the base station 210, the process may involve leveraging stored session information to re-establish connectivity. In IDLE MODE, the UE 202 may not be actively exchanging user data but remains registered with the network. The last NF within the NF-Set 230 that managed the UE's 202 session before it entered IDLE MODE is typically stored as part of the UE's 202 session context. This information may be retained both on the UE 202 and within the core network 218 (e.g., the SMF 220 and AMF). When the UE 202 transitions out of IDLE MODE, the AMF may use the stored session data to determine the last NF that managed the UE 202, such as NF 231. This information helps the AMF to direct the reconnection process to NF 231.

When NF 231 experiences a failure or undergoes an update, the SMF 220 may receive a failure notification from the NRF. This notification may inform the SMF 220 that NF 231 is temporarily unavailable. Upon receiving this failure notification, the SMF 220 may update its internal session database to reflect the unavailability of NF 231 and query the NRF for a discovery response to identify alternative NFs within the NF-Set 230, such as NF 232 or NF 233. The SMF 220 may then migrate subscriber session data of the UE 202 to the alternative NF.

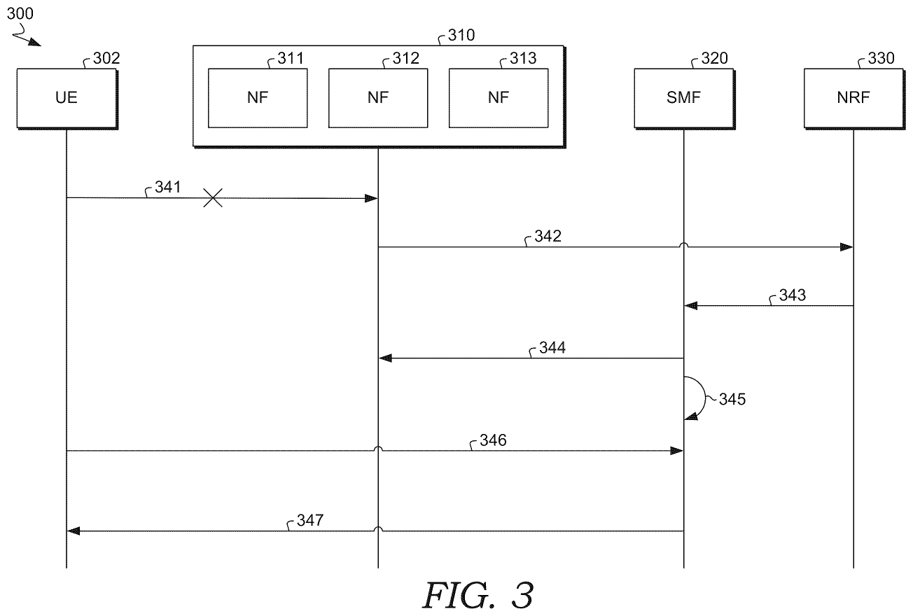

Solutions to address the conflict problems arising during NF updates or failures will be discussed in greater detail with reference to FIGS. 3-5. These solutions may leverage coordinated signaling and state management mechanisms implemented by the SMF 220. Included in some solutions is the use of a configurable timer managed by the SMF 220, which may help resolve timing conflicts between network-initiated and user-initiated procedures. By introducing a delay before initiating certain signaling processes, the configurable timer may allow the SMF 220 to prioritize critical updates, synchronize session transitions, and prevent procedure collisions.

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a UE 302, an NF-Set 310 comprising NFs 311-313, an SMF 320, and an NRF 330. In some aspects, the components discussed may be the same or similar to the corresponding components from FIG. 2 discussed above.

FIG. 3 illustrates an example method for mitigating service interruptions for a user equipment (UE) in a communications network. At a first step 341, an NF within the NF-Set 310, such as NF 311, which was the last assigned NF managing UE 302 before the UE 302 went into IDLE MODE, experiences a failure or is taken offline for an update. This event may disrupt the NF's ability to handle ongoing session management tasks for UE 302. At a second step 342, the NRF may detect the outage of NF 311 within the NF-Set 310. The NRF may continuously track the operational status of all registered NFs in the communications network.

At a third step 343, the SMF 320 may receive a failure notification from the NRF regarding the unavailability of NF 311. The NRD may send this notification as part of its real-time status monitoring and alerting mechanism. The failure notification may contain information about the status change of NF 311, including its instance identifier and/or the type of event (e.g., failure or update). The receipt of this notification may also trigger the SMF 320 to initiate discovery procedures to identify alternative NFs within the NF-Set 310, such as NF 312 or NF 313, that can take over the responsibilities of NF 311. At a fourth step 344, the SMF 320 may initiate the migration of the subscriber session data associated with the UE 302 from the failed or unavailable NF 311 to the new alternative NF. Once the new NF is selected (e.g., NF 312), the SMF 320 may update its internal session database to associate with UE 302 with NF 312.

At a fifth step 345, the SMF 320 may initiate a configurable timer as a part of its strategy to manage signaling coordination and prevent conflicts during the migration process. For example, after successfully reallocating the subscriber session data of UE 302 to a new NF, the SMF 320 may start the timer to introduce a controlled delay before triggering further signaling procedures, such as N1N2 messages to the UE 302. The configurable timer may allow the SMF 320 to prioritize other concurrent processes, such as completing the session database synchronization with the new NF. The timer duration may be dynamically set based on predefined policies or real-time network conditions, such as the load on the NF-Set 310, the number of UEs affected by the NF 311 failure, and/or the expected signaling traffic. By waiting for the timer to expire before initiating certain additional procedures, the SMF 320 helps minimize the likelihood of simultaneous signaling triggers, such as a network-initiated procedure and a UE-initiated IDLE MODE exit procedure, which could otherwise result in conflicts or session termination.

At a sixth step 346, the SMF 320 may receive a request from UE 302 to initiate IDLE MODE exit procedures. This UE-initiated request may occur when the UE 302 attempts to transition from IDLE MODE to ACTIVE MODE. The request may be forwarded to the SMF 320 via a base station (e.g., base station 210). At a seventh step 347, the SMF 320 may evaluate the status of the configurable timer initiated in step 345 and determine that the timer has not yet expired. The SMF 320 may then halt any pending network-initiated signaling procedures that were deferred by the timer when the UE's 302 IDLE MODE exit procedure is recognized as a higher priority. The SMF 320 may then collaborate with the newly assigned NF (e.g., NF 312) to process the IDLE MODE exit procedure for UE 302. Through this process, the SMF 320 may successfully complete the migration of the UE's 302 subscriber session data to NF 312. In this situation, by prioritizing the UE's request over other signaling processes, the SMF 320 helps mitigate service interruptions for the UE 302.

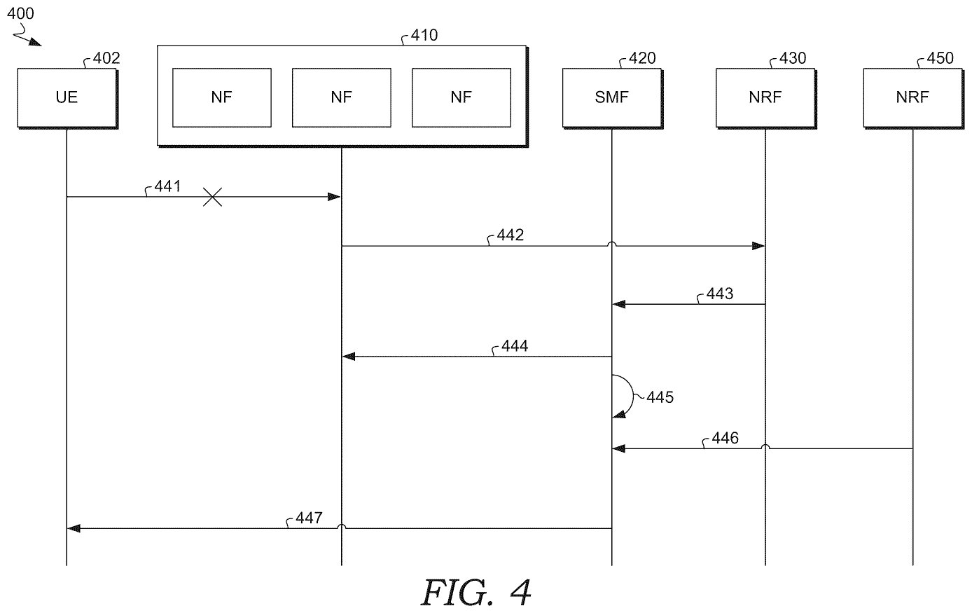

Turning now to FIG. 4, a flow diagram is illustrated in accordance with one or more aspects of the present disclosure. A flow diagram 400 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 400 may be relevantly said to include a UE 402, an NF-Set 410 comprising NFs 411-413, an SMF 420, an NRF 430, and a PCF 450. In some aspects, the components discussed may be the same or similar to the corresponding components from FIG. 2 discussed above.

Steps 441-445 may be substantially the same or similar to steps 341-345 described above with regards to FIG. 3. However, at a sixth step 346, the SMF 420 may receive a dedicated bearer setup notification from the PCF. This notification may be associated with the UE 402 and may be intended to establish a dedicated bearer to support a specific application or service. Furthermore, at a seventh step 447, the SMF 420 may determine that the configurable timer initiated at step 445 has expired. With the timer's expiration, the SMF 420 may transition from its waiting state and begin processing deferred signaling procedures. The SMF 420 may initiate state transition signaling to the UE 402, which may involve sending an N1N2 message. Such messaging initiates the transition of the UE 402 from its prior state (e.g., IDLE MODE or an interim state) to ACTIVE MODE.

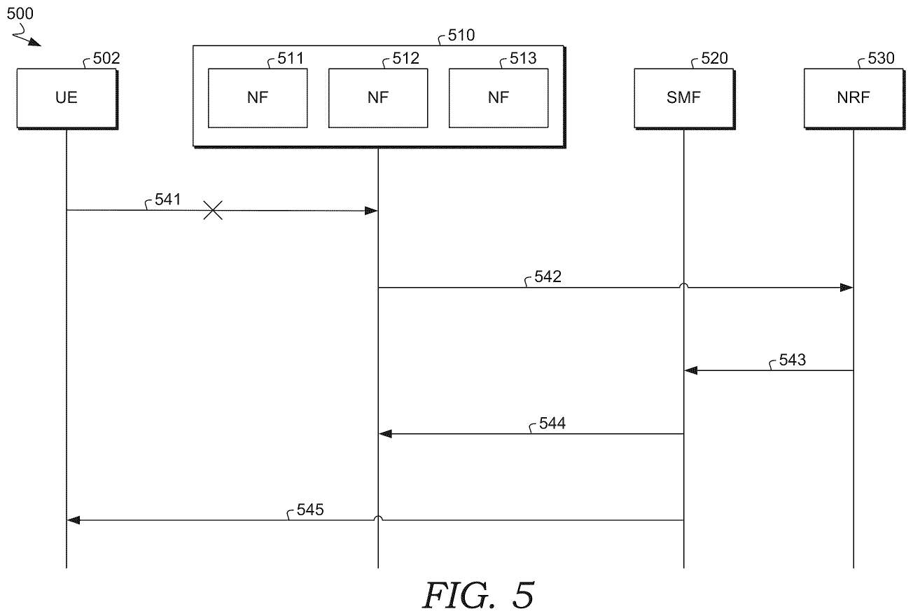

Turning now to FIG. 5, a flow diagram is illustrated in accordance with one or more aspects of the present disclosure. A flow diagram 500 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 500 may be relevantly said to include a UE 02, an NF-Set 510 comprising NFs 511-513, an SMF 520, and an NRF 530. In some aspects, the components discussed may be the same or similar to the corresponding components from FIG. 2 discussed above.

Steps 541-544 may be substantially the same or similar to steps 341-344 described above with regards to FIG. 3. However, at a fifth step 545, the SMF 520 may adopt a proactive approach by bypassing the use of a configurable timer and immediately initiating state transition signaling for a plurality of UEs, including UE 302, that were in IDLE MODE during the migration process. This approach helps ensure that all impacted UEs are transitioned to ACTIVE MODE under the SMF's 520 direct control before any potential signaling collisions can occur between network-initiated and UE-initiated procedures. For example, upon detecting the failure or update of NF 511 in the NF-Set 510 and completing the reassignment of session contexts to the new NF 512, the SMF 520 may direct N1N2 messages for each affected UE. Such immediate action helps eliminate the possibility of simultaneous network-initiated procedures (e.g., dedicated bearer setups) and UE-initiated IDLE MODE exit requests, as the SMF 520 preemptively transitions all UEs to ACTIVE MODE. Once the state transition signaling is completed, each UE may be fully integrated with NF 512.

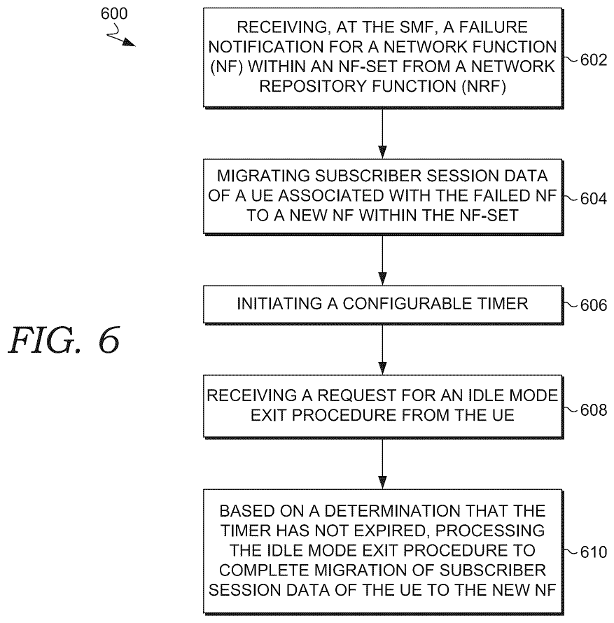

Turning now to FIG. 6, a flow chart is provided that illustrates one or more aspects of the present disclosure relating to a method 600 for mitigating service interruptions for a user equipment (UE) in a communications network. For example, at a first step 602, a failure notification for a Network Function (NF) within an NF-Set from a Network Repository Function (NRF) is received at the SMF. At a second step 604, subscriber session data of a UE associated with the failed NF is migrated to a new NF within the NF-Set. At a third step 606, a configurable timer is initiated. At a fourth step 608, a request for an IDLE MODE exit procedure is received from the UE. At a fifth step 610, based on a determination that the timer has not expired, the IDLE MODE exit procedure is processed to complete migration of subscriber data of the UE to the new NF.

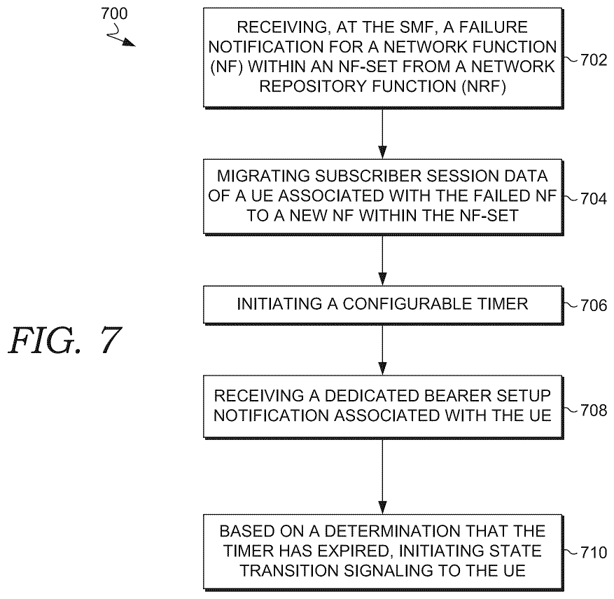

Turning now to FIG. 7, a flow chart is provided that illustrates one or more aspects of the present disclosure relating to a method 700 for mitigating service interruptions for a user equipment (UE) in a communications network. For example, at a first step 702, a failure notification for a Network Function (NF) within an NF-Set from a Network Repository Function (NRF) is received at the SMF. At a second step 704, subscriber session data of a UE associated with the failed NF is migrated to a new NF within the NF-Set. At a third step 706, a configurable timer is initiated. At a fourth step 708, a dedicated bearer setup notification associated with the UE is received. At a fifth step 710, state transition signaling to the UE is initiated based on a determination that the timer has expired.

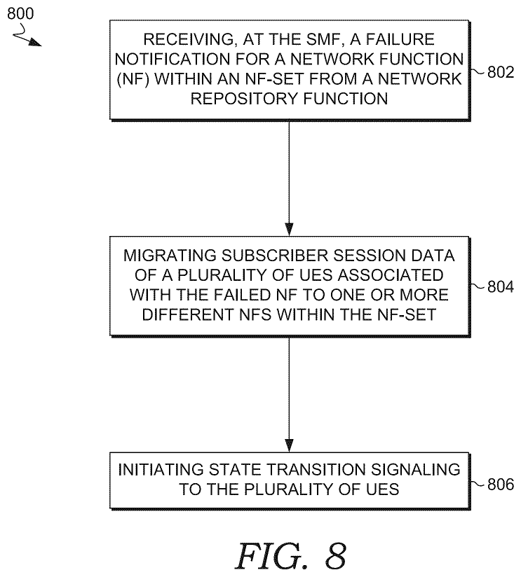

Turning now to FIG. 8, a flow chart is provided that illustrates one or more aspects of the present disclosure relating to a method 800 for mitigating service interruptions for a plurality of user equipment (UE) in a communications network. For example, at a first step 802, a failure notification for a Network Function (NF) within an NF-Set from a Network Repository Function (NRF) is received at the SMF. At a second step 804, subscriber session data of the plurality of UEs associated with the failed NF is migrated to a one or more different NFs within the NF-Set. At a third step 806, state transition signaling to the plurality of UEs is initiated.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating service interruptions for a user equipment (UE) in a communications network, the system comprising:
a Session Management Function (SMF) comprising one or more processors; and
a non-transitory computer-readable media comprising executable instructions that, when executed, causes the SMF to perform operations in the communication network, comprising:
receiving, at the SMF, a failure notification for a Network Function (NF) within an NF-Set from a Network Repository Function (NRF);
migrating subscriber session data of the UE associated with the failed NF to a new NF within the NF-Set;
initiating a configurable timer;
receiving a request for an IDLE MODE exit procedure from the UE; and
based on a determination that the timer has not expired, processing the IDLE MODE exit procedure to complete migration of subscriber session data of the UE to the new NF.

2. The system of claim 1, further comprising receiving, at the SMF, a dedicated bearer setup notification prior to receiving the IDLE MODE exit procedure request from the UE.

3. The system of claim 2, further comprising delaying the dedicated bearer setup at least until the timer has expired.

4. The system of claim 3, further comprising initiating N1N2 messages to the UE based on a determination that the timer has expired.

5. The system of claim 2, further comprising prioritizing the IDLE MODE exit procedure request from the UE based on the determination that the time has not expired.

6. The system of claim 1, wherein the IDLE MODE exit procedure causes the UE to transition to an ACTIVE MODE.

7. The system of claim 1, wherein the configurable timer is dynamically adjusted based on signaling load or the number of UEs in the NF-Set.

8. The system of claim 1, wherein the new NF is selected based on a discovery response.

9. A system for mitigating service interruptions for a user equipment (UE) in a communications network, the system comprising:
a Session Management Function (SMF) comprising one or more processors; and
a non-transitory computer-readable media comprising executable instructions that, when executed, causes the SMF to perform operations in the communication network, comprising:
receiving, at the SMF, a failure notification for a Network Function (NF) within an NF-Set from a Network Repository Function;
migrating subscriber session data of the UE associated with the failed NF to a new NF within the NF-Set;
initiating a configurable timer;
receiving a dedicated bearer setup notification associated with the UE; and
based on a determination that the timer has expired, initiating state transition signaling to the UE.

10. The system of claim 9, wherein the state transition signaling causes the UE to transition from IDLE MODE to ACTIVE MODE.

11. The system of claim 9, wherein the dedicated bearer setup notification is received from a Policy Control Function (PCF).

12. The system of claim 9, wherein the new NF is selected based on a discovery response.

13. The system of claim 9 further comprising delaying the dedicated bearer setup at least until the timer has expired.

14. The system of claim 9, wherein initiating state transition signaling to the UE comprises sending N1N2 messaging to the UE.

15. The system of claim 9, wherein the configurable timer is dynamically adjusted based on signaling load or the number of UEs in the NF-Set.

16. A system for mitigating service interruptions for a plurality of user equipment (UE) in a communications network, the system comprising:
a Session Management Function (SMF) comprising one or more processors; and
a non-transitory computer-readable media comprising executable instructions that, when executed, causes the SMF to perform operations in the communications network, comprising:
receiving, at the SMF, a failure notification for a Network Function (NF) within an NF-Set from a Network Repository Function;
migrating subscriber session data of the plurality of UEs associated with the failed NF to one or more different NFs within the NF-Set; and
initiating state transition signaling to the plurality of UEs.

17. The system of claim 16, wherein the state transition signaling causes each UE of the plurality of UEs to transition from IDLE MODE to ACTIVE MODE.

18. The system of claim 16, wherein the plurality of UEs comprises UEs that are in an IDLE MODE prior to receiving the state transition signaling.

19. The system of claim 16, wherein the state transition signaling is initiated prior to receiving a request for an IDLE MODE exit procedure from the plurality of UEs.

20. The system of claim 16, wherein initiating state transition signaling to the UE comprises sending N1N2 messaging to each UE of the plurality of UEs.
